(19) United States
(12) Patent Application Publication
(10) Pub. No.: US 2008/0248438 A1
(43) Pub. Date: Oct. 9, 2008

(54) ORTHODONTIC APPLIANCES AND MATERIALS FOR MAKING SAME

(76) Inventors: Joseph M. DeSimone, Chapel Hill, NC (US); Robert E. Tricca, Danville, CA (US)

Correspondence Address: Needham James Boddie, II;Myers Bigel Sibley & Sajovec, P.A., P.O. Box 37428, Raleigh, NC, 27627, US

(21) Appl. No.: 11/947,172

(22) Filed: Nov. 29, 2007

Related U.S. Application Data
(62) Division of application No. 10/963,147, filed on Oct. 12, 2004.

(51) Int. Cl. A61C 3/00

(52) U.S. Cl. 433/6

(57) ABSTRACT

The polymeric shell of a removable dental positioning appliance is formed from transparent polymeric materials having a tensile strength at yield of greater than 6,000 pounds per square inch (psi), an elongation at yield of greater than 4%, an elongation at break of greater than 80%, a tensile modulus greater than 200,000 psi, a flexural modulus greater than 200,000 psi, stress relaxation over time of not more than 50%, and a transmissivity of light between 400 nm and 800 nm greater than 75%.

### FIELD OF THE INVENTION

The present invention relates generally to orthodontics and, more particularly, to orthodontic appliances for incrementally moving teeth from an initial tooth arrangement to a final tooth arrangement.

### BACKGROUND OF THE INVENTION

Orthodontic treatments involve repositioning misaligned teeth and improving bite configurations for improved cosmetic appearance and dental function. Repositioning teeth is accomplished by applying controlled forces to the teeth over an extended period of time. This is conventionally accomplished by wearing what are commonly referred to as “braces.” Braces include a variety of appliances such as brackets, bands, archwires, ligatures, and O-rings. After braces are bonded to the teeth, periodic meetings with an orthodontist are typically required to adjust the braces. This may involve installing different archwires with different force-inducing properties and/or may include replacing or tightening existing ligatures. Between meetings, the patient may be required to wear supplementary appliances, such as elastic bands or headgear, to supply additional or extraoral forces.

Although conventional braces can be effective, their use often is a tedious and time consuming process that requires many visits to an orthodontist. Moreover, from a patient's perspective, braces are unsightly and uncomfortable. Consequently, alternative orthodontic treatments have developed. A particularly promising approach relies on the use of elastic positioning appliances for realigning teeth. Such appliances comprise a thin shell of elastic material that generally conforms to a patient's teeth, but that is slightly out of alignment with the patient's initial tooth configuration. Placement of the elastic positioner over the teeth applies controlled forces in specific locations to gradually move the teeth into the new configuration. Repetition of this process with successive appliances having different configurations eventually moves a patient's teeth through a series of intermediate configurations to a final desired configuration. A full description of exemplary elastic polymeric positioning appliances and methods of using same are described in U.S. Pat. No. 5,975,893, commonly assigned to the assignee of the instant invention and which is incorporated herein by reference in its entirety.

Polymeric positioning appliances, such as those described in the '893 patent, are advantageous over conventional braces in that they are easy to use and they are generally transparent, providing an improved cosmetic appearance. Unfortunately, polymeric materials currently utilized in the production of these positioning appliances may undergo stress relaxation and creep, which can seriously degrade the ability of an appliance to reposition teeth as desired. In addition, polymeric materials currently utilized may be susceptible to degradation as a result of exposure to saliva and other chemicals present within a patient's mouth.

### SUMMARY OF THE INVENTION

According to embodiments of the present invention, the polymeric shell of a removable dental positioning appliance is formed from, or coated with, transparent polymeric materials such as liquid crystalline polymeric materials, styrenics, and/or ion-containing polymers. These transparent polymeric materials preferably have a tensile strength at yield of greater than 6,000 pounds per square inch (psi), preferably have an elongation at yield of greater than 4%, an elongation at break of greater than 80%, preferably have a tensile modulus greater than 200,000 psi, preferably have a flexural modulus greater than 200,000 psi, stress relaxation over time of not more than 50%, and preferably have a transmissivity of light between 400 nm and 800 nm greater than 75%.

According to other embodiments of the present invention, the polymeric shell of a removable dental positioning appliance is formed from, or coated with, transparent polymeric materials having high glass transition temperatures (e.g., T_{g} of at least 155° C.). These transparent polymeric materials preferably have a tensile strength at yield of greater than 6,000 pounds per square inch (psi), preferably have an elongation at yield of greater than 4%, preferably have an elongation at break of greater than 80%, preferably have a tensile modulus greater than 200,000 psi, preferably have a flexural modulus greater than 200,000 psi, preferably have stress relaxation over time of not more than 50%, and preferably have a transmissivity of light between 400 nm and 800 nm greater than 75%.

According to other embodiments of the present invention, the polymeric shell of a removable dental positioning appliance is formed from, or coated with, transparent polymeric laminates and/or blends of transparent polymeric materials that preferably have a tensile strength at yield of greater than 6,000 pounds per square inch (psi), preferably have an elongation at yield of greater than 4%, preferably have an elongation at break of greater than 80%, preferably have a tensile modulus greater than 200,000 psi, preferably have a flexural modulus greater than 200,000 psi, preferably have stress relaxation over time of not more than 50%, and preferably have a transmissivity of light between 400 nm and 800 nm greater than 75%.

### BRIEF DESCRIPTION OF THE DRAWINGS

FIG. 1 is a perspective view of a removable dental positioning appliance that may be formed from and/or coated with various materials in accordance with embodiments of the present invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

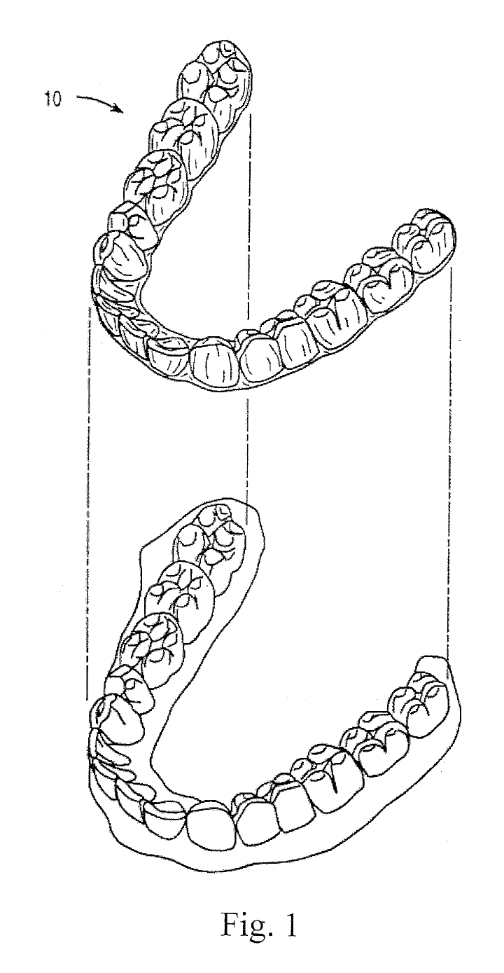

U.S. Pat. No. 5,975,893 describes methods and systems for repositioning a patient's teeth from an initial tooth arrangement to a final tooth arrangement by placing a series of polymeric shell appliances in the patient's mouth. The appliances are not affixed to the patient's teeth and the patient may place and replace the appliances at any time during the procedure. The first appliance of the series has a geometry selected to reposition the teeth from the initial tooth arrangement to a first intermediate arrangement. After the first intermediate arrangement is approached or achieved, one or more additional (intermediate) appliances are successively placed on the teeth, where such additional appliances have geometries selected to progressively reposition teeth from the first intermediate arrangement through successive intermediate arrangement(s). The treatment is finished by placing a final appliance in the patient's mouth, where the final appliance has a geometry selected to progressively reposition teeth from the last intermediate arrangement to the final tooth arrangement. FIG. 1 illustrates an exemplary dental positioning appliance 10 described in the '893 patent.

The polymeric shells of dental positioning appliances for a patient, such as illustrated in FIG. 1, are produced by initially obtaining a digital data set (IDDS) representing an initial tooth arrangement. The IDDS may be obtained in a variety of ways. For example, the patient's teeth may be scanned or imaged using well known technology, such as X-rays, three-dimensional x-rays, computer-aided tomographic images or data sets, magnetic resonance images, etc. The IDDS is then digitally manipulated via a computer to produce a final tooth arrangement, which is incorporated into a final digital data set (FDDS). Based on both the IDDS and the FDDS, a plurality of intermediate digital data sets (INTDDS's) are generated to correspond to successive intermediate tooth arrangements that correspond to tooth movement from the initial tooth arrangement to the final tooth arrangement.

Using the intermediate and final data sets, positive tooth models of a patient's teeth corresponding to each of the intermediate and final data sets are produced. After the positive models are prepared, a conventional pressure or vacuum molding machine may be used to produce the polymer shells of dental positioning appliances from a thermoformable material. The molding machine produces each of the appliances directly from a positive tooth model. The appliances are marked in some manner, typically by sequential numbering directly on the appliances or on tags, pouches, or other items which are affixed to or which enclose each appliance, to indicate their order of use.

According to embodiments of the present invention, removable dental positioning appliances, such as illustrated in FIG. 1, with improved material properties are provided. In each of the embodiments described herein, a removable dental positioning appliance may be formed from a particular material or materials and/or may be coated with the particular material or materials.

According to embodiments of the present invention, the polymeric shell of a removable dental positioning appliance is formed from transparent polymeric materials such as liquid crystalline polymeric materials, styrenics, and ion-containing polymers. Preferably, these transparent polymeric materials have a glass transition temperature of at least 50° C. and/or a melting point of at least 150° C. Preferably, these transparent polymeric materials have a tensile strength at yield of greater than 6,000 pounds per square inch (psi), preferably have an elongation at yield of greater than 4%, preferably have an elongation at break of greater than 80%, preferably have a tensile modulus greater than 200,000 psi, preferably have a flexural modulus greater than 200,000 psi, preferably have stress relaxation over time of not more than 50%, and preferably have a transmissivity of light between 400 nm and 800 nm greater than 75%. Even more preferably, these transparent polymeric materials have a tensile strength at yield of greater than 8,800 psi, preferably have an elongation at yield of greater than 5%, preferably have an elongation at break of greater than 100%, preferably have a tensile modulus greater than 300,000 psi, preferably have a flexural modulus greater than 330,000 psi, preferably have stress relaxation over time of not more than 30%, and preferably have a transmissivity of light between 400 nm and 800 nm greater than 80%.

Applicants have discovered that removable dental positioning appliances formed from liquid crystalline polymers, styrenics, and ion-containing polymers and having one or more of the above-listed characteristics are less susceptible to stress relaxation and creep than conventional dental positioning appliances. Moreover, Applicants have discovered that removable dental positioning appliances formed from liquid crystalline polymers, styrenics, and ion-containing polymers and having one or more of the above-listed characteristics are mechanically stable and less susceptible to degradation caused by exposure to saliva and other chemicals in a patient's mouth. The term “mechanically stable” means that removable dental positioning appliances, according to embodiments of the present invention, avoid structural and/or cosmetic failure during normal use.

Exemplary liquid crystalline polymeric materials according to embodiments of the present invention include, but are not limited to branched liquid crystalline polymers and polyarylates. Crystallizable polyester compositions described in U.S. Pat. No. 5,405,921, which is incorporated herein by reference in its entirety, are also suitable. Crystallizable polyesters utilized in accordance with embodiments of the present invention preferably have a glass transition temperature of at least 50° C. and a melting point of at least 150° C. In terms of intrinsic viscosity (IV), crystallizable polyesters should have an IV of at least about 0.5 as measured in a 1:1 by weight solution of methylene chloride and trifluoroacetic acid. The polyester base resin preferably is present in an amount of about 79-99 wt % based upon the total weight of the formulations used in the practice of this invention. A single polyester material need not be used, and copolyesters, blends, etc. may alternatively be used.

To obtain a clear product based upon crystallized polyester, the polymer must be oriented prior to the onset of crystallization. The orientation of the polyester results in the formation of elongated crystallites. Elongated crystallites allow incident light to pass without substantial diffraction, which results in a clear, transparent product.

Other exemplary crystalline polymeric materials that may be utilized in accordance with embodiments of the present invention include polyethylene terephthalate (PET) (e.g., DuPont Teijin Films Melinex® and polyethylene naphthalate (PEN) films (e.g., DuPont Teijin Films Teonex®. PET and PEN films have an inherent advantage over amorphous polymer films because PET and PEN are both semi-crystalline and biaxially oriented polymers. Moreover, PET and PEN films will typically absorb approximately 1,400 ppm of moisture at equilibrium.

According to other embodiments of the present invention, dental positioning appliances may be formed from PVC modified with Elvaloy® ketone ethylene ester (DuPont, Wilmington, Del.). Elvaloy® modified PVC has been found to be more resistant to creep than PVC and HDPE.

Exemplary styrenic polymeric materials according to embodiments of the present invention include, but are not limited to polystyrene (PS), expanded polystyrene (EPS), acrylonitrile-butadiene-styrene (ABS), styrene-acrylonitrile (SAN), styrene block copolymers (SBC), unsaturated polyester resins (uPES), styrene butadiene rubber (SBR), and styrene butadiene latex (SBL). Styrenic polymeric materials are rigid, transparent, tough, resistant to grease, stress cracking and crazing. Styrenic polymeric materials are also easily processed and resistant to food stains. Styrenic polymeric materials are available from a variety of sources including Bayer AG, Leverkusen, Germany, The Dow Chemical Company, Midland, Mi., and PolyOne Corporation, Avon Lake, Ohio.

Exemplary ion-containing polymeric materials include, but are not limited to, Surlyn® brand resin (DuPont, Inc., Wilmington, Del.). Other important commercial ionomers include Nafion® brand polymers (Ion Power, Inc., Bear, Del.). Nafion® brand polymers are sulfonated tetrafluorethylene ionomer and sulfonated polystyrene. Ionomers have significantly better properties than the un-ionized precursor because the ionic groups phase separate into ion-rich domains.

According to other embodiments of the present invention, removable dental positioning appliances having a polymeric shell formed from transparent polymeric material with high glass transition temperatures (e.g., at least 155° C.) are provided. Preferably, the transparent polymeric material has a tensile strength at yield of greater than 6,000 pounds per square inch (psi), preferably has an elongation at yield of greater than 4%, preferably has an elongation at break of greater than 80%, preferably has a tensile modulus greater than 200,000 psi, preferably have a flexural modulus greater than 200,000 psi, preferably has stress relaxation over time of not more than 50%, and preferably has a transmissivity of light between 400 nm and 800 nm greater than 75%. Even more preferably, the transparent polymeric material has a tensile strength at yield of greater than 8,800 psi, preferably has an elongation at yield of greater than 5%, preferably has an elongation at break of greater than 100%, preferably has a tensile modulus greater than 300,000 psi, preferably has a flexural modulus greater than 330,000 psi, preferably has stress relaxation over time of not more than 30%, and preferably has a transmissivity of light between 400 nm and 800 nm greater than 80%. According to embodiments, the high glass transition temperature material may also have a melting point of at least 150° C.

Applicants have discovered that removable dental positioning appliances formed from polymeric materials with high glass transition temperatures (e.g., a glass transition temperature of at least 155° C.) and having one or more of the above-listed characteristics are less susceptible to stress relaxation and creep than conventional dental positioning appliances. Moreover, Applicants have discovered that removable dental positioning appliances formed from polymeric materials with high glass transition temperatures and having one or more of the above-listed characteristics are less susceptible to degradation caused by exposure to saliva and other chemicals in a patient's mouth.

Exemplary transparent polymeric materials having high glass transition temperatures include, but are not limited to norbornene-containing polymers, metallocene, metal-catalyzed polyolefins, cyclo-olefins, poly(methyl-1-pentene), amorphous aromatic resins, poly(benzophenone)s, polyamides, thermoplastic polyurethanes, polyetherimides, poly(arylene ether ketone)s, polysulfones, biphenyl endcapped poly(acrylene ether) polymers, polycarbonates, polyesters, poly(estercarbonate)s, cellulosics, and acrylics.

Other exemplary transparent materials having high glass transition temperatures include Paramax® (Mississippi Polymer Technologies) and polyamides. Paramax® is a very hard polymer with a low coefficient of thermal expansion, and a high refractive index. Paramax® can be molded extruded and cast from solution and produces clear alloys with other engineering thermoplastics. Paramax® is miscible with polycarbonate and polysulfone. Paramax® has a high surface hardness which provides excellent scratch resistance.

Other exemplary transparent materials having high glass transition temperatures include SUNTUF®, PALSUN® and PALTUF™ polycarbonate sheets, PALGLAS® acrylic sheets; PAL-G™ co-polyester sheets, and PALRUF® PVC sheets, all available from Suntuf, Inc. Kutztown, Pa.

According to embodiments of the present invention, transparent acrylic and polycarbonate materials having high glass transition temperatures are processed with a supermicrocellular foaming technique developed by Wright Materials Research Co., Beavercreek, Ohio. This technique utilizes biphenyl endcapped poly(acrylene ether) polymers.

Other exemplary transparent materials having high glass transition temperatures include Trogamid® brand transparent polyamides (Degussa AG, Marl, Germany). Trogamid® brand transparent polyamides are permanently transparent, have high chemical resistance, and have a low tendency to creep.

According to other embodiments of the present invention, removable dental positioning appliances having a polymeric shell formed from laminates and/or blends of transparent polymeric materials are provided. Preferably, the transparent polymeric materials have a tensile strength at yield of greater than 6,000 pounds per square inch (psi), preferably have an elongation at yield of greater than 4%, preferably have an elongation at break of greater than 80%, preferably have a tensile modulus greater than 200,000 psi, preferably have a flexural modulus greater than 200,000 psi, preferably have stress relaxation over time of not more than 50%, and preferably have a transmissivity of light between 400 nm and 800 nm greater than 75%. Even more preferably, the transparent polymeric materials have a tensile strength at yield of greater than 8,800 psi, preferably have an elongation at yield of greater than 5%, preferably have an elongation at break of greater than 100%, preferably have a tensile modulus greater than 300,000 psi, preferably have a flexural modulus greater than 330,000 psi, preferably have stress relaxation over time of not more than 30%, and preferably have a transmissivity of light between 400 nm and 800 nm greater than 80%.

Applicants have discovered that removable dental positioning appliances formed from laminates and/or blends of transparent polymeric materials that have one or more of the above-listed characteristics are less susceptible to stress relaxation and creep than conventional dental positioning appliances. Moreover, Applicants have discovered that removable dental positioning appliances formed from laminates and/or blends of transparent polymeric materials that have one or more of the above-listed characteristics are less susceptible to degradation caused by exposure to saliva and other chemicals in a patient's mouth.

Exemplary blends of transparent polymers include, but are not limited to, polyester blends such as polybutylene terephthalate (PBT) blends and polyethylene terephthalate (PET) blends. Polyester blends, in general, have high strength and rigidity.

Exemplary transparent laminates include, but are not limited to, polycarbonate-based laminates, acrylic-based laminates, Paramax® brand polymers, polycarbonates, and polysulfone.

In each of the above-described embodiments, the transparent polymeric material of the dental positioning appliance is configured to be mechanically stable in a saliva environment. Moreover, the transparent polymeric material is configured to be chemically resistant to teeth cleaning materials including, but not limited to, dentifrice, oral rinse, denture cleaner, detergent and bleach. The term “chemically resistant” means that dental position appliances according to embodiments of the present invention avoid structural and/or cosmetic failure during normal use.

Exemplary dentifrice compositions for which embodiments of the present invention are resistant may include, but are not limited to, insoluble polishing agents (e.g., silicas, insoluble sodium metaphosphate, tricalcium phosphate, calcium phosphate dihydrate, calcium pyrophosphate, etc.), polyphosphate anti-calculus agents (e.g., tetrapotassium pyrophosphate, tetrasodium pyrophosphate, sodium tripolyphosphate, etc.), and surface active agents (e.g., sodium lauryl sulfate, sodium dodecyl benzene sulfonates, and Pluronics (block copolymers of ethylene oxide and propylene oxide)).

Exemplary oral rinses for which embodiments of the present invention are resistant may include, but are not limited to, ethyl alcohol (5-30% w/w), humectants (e.g., glycerine, sorbitol), flavorants (essential oils) (e.g., methyl salicylate, eucalyptol, thymol, menthol, cinnamic aldehyde, peppermint, etc.), and auxiliary agents (e.g., fluoride, zinc salts, etc.).

Exemplary denture cleaning formulations (e.g., dishwashing detergents, cleaners and sanitizers, etc.) for which embodiments of the present invention are resistant may include, but are not limited to, detergent builders (e.g., sodium silicates, sodium carbonate, sodium hydroxide, sodium bicarbonate, etc.), fillers (e.g., sodium sulfate), sequestrants (sodium tripolyphosphate, sodium citrate), surfactants (e.g., linear alkylbenzene sulfonates, polyoxyethylated and polyoxypropylated glycols). These formulations may also include bleaching agents such as sodium dichloroisocyanurate and calcium hypochlorite that release low levels of chlorine when dissolved in water. Denture cleaning tablets formulated with effervescing agents such as peroxygen compounds (e.g., sodium perborate monohydrate, sodium carbonate peroxyhydrate, potassium monopersulfate, etc.), detergent compounds (e.g., anionic, nonionic surfactants), alkaline builders (e.g., sodium carbonate, trisodium phosphate), sequestrants (e.g., ethylene diamine tetraacetic acid, citric acid, maleic acid), and additives such as flavorings (e.g., mints, oil of clove) and colorants (e.g., FD&C Blue #1, FD&C Green #1).

In each of the above-described embodiments, the transparent polymeric material of the dental positioning appliance may include uniaxially oriented polymers and/or bi-axially oriented polymers.

In each of the above-described embodiments, the transparent polymeric material of the dental positioning appliance may include filler material including, but not limited to, inorganic materials and/or organic materials. Exemplary inorganic filler materials include, but are not limited to, metal oxides, oxygenates, carbonates, halides, and sulfates. U.S. Pat. Nos. 5,372,796 and 5,670,583, each of which is incorporated herein by reference in its entirety, describe metal oxide clusters and ceramers (polymer-ceramic composites). According to embodiments of the present invention, alloys of polymers with ceramic particles of diameter much smaller than the wavelength of visible light can be used to produce a material with a high refractive index, and that are scratch and corrosion resistant. Exemplary organic filler materials include, but are not limited to, waxes and oligomeric polymers.

In each of the above-described embodiments, the transparent polymeric material of the dental positioning appliance may include additives, such as ultra-high molecular weight polymers. An exemplary ultra-high molecular weight polymer that may be utilized in accordance with embodiments of the present invention is ultra-high molecular weight polyethylene (UHMWPE), available from Cambridge Polymer Group, Boston, Mass. The wear properties of ultra-high molecular weight polymers, as well as other types of polymers, can be enhanced with radiation, such as electron beam and gamma irradiation.

Ionizing radiation may be utilized to enhance the material characteristics of polymers used in dental positioning appliances in accordance with embodiments of the present invention. Many important physical and chemical properties of polymers can be modified with ionizing radiation including, but not limited to, molecular weight, polymer chain length, entanglement, polydispersity, branching, pendant functionality, and chain termination. Ionizing radiation can be used to modify a polymer in a solid state, as opposed to alternative chemical and thermal reactions carried out in hot, melted polymer. Radiation, such as gamma and electron beam irradiation, may also be utilized to sterilize the polymeric material of dental positioning appliances, according to embodiments of the present invention.

Polymers treated with radiation, in accordance with embodiments of the present invention, may contain various other additives including, but not limited to, radiation stabilizers and antioxidants which act to protect the polymeric material from damage caused by the radiation. Such additives include “antirads” which may function as reactants, combining readily with radiation-generated free radicals in the polymer material, or as energy absorbers, preventing the radiation from interacting with the polymer itself. Other additives may be utilized to prevent color change that otherwise could be caused by radiation.

According to embodiments of the present invention, the polymeric shell of a removable dental positioning appliance may be coated with, transparent polymeric materials such as liquid crystalline polymeric materials, styrenics, ion-containing polymers, transparent polymeric materials having high glass transition temperatures (e.g., T_{g} of at least 155° C.), transparent polymeric laminates and/or blends of transparent polymeric materials.

According to embodiments of the present invention, the polymeric shell of a removable dental positioning appliance may be coated with other materials, including curable and non-curable materials. Exemplary curable coating materials, according to embodiments of the present invention, include, but are not limited to, epoxies, sol-gel coatings, polyurethanes, polyureas, and unsaturated polyesters. Exemplary non-curable coating materials, according to embodiments of the present invention, include, but are not limited to, acrylics, silicone, inorganic-containing materials, polycarbonates, and polyurethanes.

According to embodiments of the present invention, the polymeric shell of a removable dental positioning appliance may be coated with other materials that include Barix® brand vapor barrier film, advanced thermoplastic composite (ATC) materials. Dental positioning appliances, according to embodiments of the present invention, may be coated with other materials that serve as a barrier to harmful substances. For example, a coating of silicon dioxide may serve as a barrier to various gases and vapors (e.g. water vapor, oxygen, etc.).

Coatings of materials may be utilized to improve abrasion resistance of dental positioning appliances. For example, a coating (e.g., 3-5μ) of silicon oxide can significantly improve the abrasion resistance of polymeric materials, particularly polycarbonate.

Dental positioning appliances, according to embodiments of the present invention, may be coated with materials that avoid the formation of fog. Exemplary antifog coatings include, but are not limited to, silicon oxides.

Applicants have discovered that removable dental positioning appliances coated with materials as described above are less susceptible to stress relaxation and creep than conventional dental positioning appliances. Moreover, Applicants have discovered that removable dental positioning appliances coated with materials as described above are less susceptible to degradation caused by exposure to saliva and other chemicals in a patient's mouth.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1-35. (canceled)

36. A removable dental positioning appliance, comprising a polymeric shell having cavities shaped to receive and reposition teeth from a first orientation to a successive orientation, wherein the shell comprises transparent polymeric material selected from the group consisting of polymeric laminates and polymeric blends.

37. The removable dental positioning appliance of claim 36, wherein the transparent polymeric material has a tensile strength at yield of greater than 6,000 psi, an elongation at yield of greater than 4%, an elongation at break of greater than 80%, a tensile modulus greater than 200,000 psi, a flexural modulus greater than 200,000 psi, stress relaxation over time of not more than 50%, and a transmissivity of light between 400 nm and 800 nm greater than 75%.

38. The removable dental positioning appliance of claim 36, wherein the transparent polymeric material has a tensile strength at yield of greater than 8,800 psi, an elongation at yield of greater than 5%, an elongation at break of greater than 100%, a tensile modulus greater than 300,000 psi, a flexural modulus greater than 330,000 psi, stress relaxation over time of not more than 30%, and a transmissivity of light between 400 nm and 800 nm greater than 80%.

39. The removable dental positioning appliance of claim 36, wherein the transparent polymeric material is mechanically stable in a saliva environment.

40. The removable dental positioning appliance of claim 36, wherein the transparent polymeric material is chemically resistant to teeth cleaning materials selected from the group consisting of dentifrice, oral rinse, denture cleaner, detergent and bleach.

41. The removable dental positioning appliance of claim 40, wherein dentifrice comprises materials selected from the group consisting of insoluble polishing agents, polyphosphate anti-calculus agents, and surface active agents.

42. The removable dental positioning appliance of claim 40, wherein oral rinse comprises materials selected from the group consisting of ethyl alcohol, humectants, and auxiliary agents.

43. The removable dental positioning appliance of claim 40, wherein denture cleaner comprises materials selected from the group consisting of detergent builders, detergent compounds, alkaline builders, fillers, sequestrants, surfactants, effervescing agents, and bleaching agents.

44. The removable dental positioning appliance of claim 36, wherein the transparent polymeric material has a melting point of at least 150° C.

45. The removable dental positioning appliance of claim 36, wherein the transparent polymeric material comprises uniaxially oriented polymers.

46. The removable dental positioning appliance of claim 36, wherein the transparent polymeric material comprises bi-axially oriented polymers.

47. The removable dental positioning appliance of claim 36, wherein the transparent polymeric material comprises filler material selected from the group consisting of inorganic materials and organic materials.

48. The removable dental positioning appliance of claim 36, wherein the transparent polymeric material comprises inorganic filler material selected from the group consisting of metal oxides, oxygenates, carbonates, halides, and sulfates.

49. The removable dental positioning appliance of claim 36, wherein the transparent polymeric material comprises organic filler material selected from the group consisting of waxes and oligomeric polymers.

50. The removable dental positioning appliance of claim 36, wherein the transparent polymeric material comprises ultra-high molecular weight polymers.

51. The removable dental positioning appliance of claim 36, wherein the transparent polymeric material comprises a polymeric laminate selected from the group consisting of polycarbonate-based laminates and acrylic-based laminates.

52. The removable dental positioning appliance of claim 36, wherein the polymeric material comprises a blend of polymeric materials selected from the group consisting of Paramax® brand polymer, polycarbonates, and polysulfone.

53-79. (canceled)
